(19) United States
(12) Patent Application Publication
(10) Pub. No.: US 2020/0235629 A1
(43) Pub. Date: Jul. 23, 2020

(54) STATOR FOR AN ELECTRIC MOTOR

(71) Applicant: Nidec Corporation, Kyoto (JP)

(72) Inventors: Wojciech Antoni DOLNICKI, Niepolomice (PL); Lukasz DROZDZ, Niepolomice (PL)

(21) Appl. No.: 16/483,099

(22) PCT Filed: Feb. 6, 2018
(86) PCT No.: PCT/JP2018/003886

§ 371 Date: Aug. 2, 2019

(30) Foreign Application Priority Data
Feb. 8, 2017 (DE) 10 2017 102 495.6

(51) Int. Cl. H02K 3/34; H02K 1/18

(52) U.S. Cl. CPC H02K 3/345; H02K 1/18

(57) ABSTRACT

At least one core segment may include an electrical insulator surrounding a coil winding portion thereof to electrically insulate the at least one core segment from a coil wound therearound. The electrical insulator may include a first insulator portion including at an end portion thereof a first engagement structure with a wedge-shaped peripheral portion that includes a recess at an end thereof, and a second insulator portion including at an end portion thereof a second engagement structure including a wedge-shaped peripheral portion and a protrusion. The first and second engagement structures may be in mutual engagement or are able to be brought into mutual engagement. In an engaged state of the first and second engagement structures, the wedge-shaped peripheral portions may be in mutual physical contact, and the recess of the first engagement structure may be engaged with the protrusion of the second engagement structure.

### CROSS REFERENCE TO RELATED APPLICATIONS

This is a U.S. national stage of PCT Application No. PCT/JP2018/003886, filed on Feb. 6, 2018, and priority under 35 U.S.C. § 119(a) and 35 U.S.C. § 365(b) is claimed from German Application No. 102017102495.6, filed Feb. 8, 2017; the entire disclosures of each application are incorporated herein by reference.

### FIELD OF THE INVENTION

Various example embodiments relate generally to a stator for an electric motor.

### BACKGROUND

Electric motors have become essential in a large variety of driving systems, in particular in mobile environments such as in vehicles. A key parameter that is subject to permanent optimization is the volume of driving systems of this kind. The provision of electric motors with small volumes require a space-saving arrangement of the coils of the electric motor that are configured to generate a time-varying magnetic field required for rotating a rotor which in turn requires a reliable electric insulation at least between the coils.

The coils of an electric motor are wound around stator core segments constituting a stator core. The coils are usually not directly wound around respective stator core segments, but physically separated and electrically isolated from the stator core segments by means of electrically insulating members interposed between the coils and the corresponding stator core segments to avoid short circuits between the coils and the stator core segments.

In order to ensure a reliable electrical insulation in this respect, the electrically insulating members have to be configured to be positionable on the stator core segments in a defined manner and to maintain their positions even when forces are exerted thereon.

### SUMMARY

According to various example embodiments of the present disclosure, stators for electric motors are provided. Each stator may have a substantially annular shape centered around a central axis and may include a plurality of core segments consecutively arranged in the circumferential direction of the stator. Each core segment may include a coil winding portion around which respective coils are to be wound. At least one core segment may include an electrical insulator surrounding the coil winding portion thereof to electrically insulate the at least one core segment from a coil wound around the at least one core segment. The electrical insulator may include a first insulator portion including at an end portion thereof a first engagement structure with a wedge-shaped peripheral portion that includes a recess at an end thereof, and a second insulator portion including at an end portion thereof a second engagement structure including a wedge-shaped peripheral portion and a protrusion. The first and second engagement structures may be in mutual engagement or are able to be brought into mutual engagement. In an engaged state of the first and second engagement structures, the wedge-shaped peripheral portions may be in mutual physical contact, and the recess of the first engagement structure may be engaged with the protrusion of the second engagement structure.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 shows a schematic plan view of a stator for an electric motor.

FIG. 2 shows a perspective view of a stator core segment including an electrically insulating member.

FIG. 3 shows a perspective view of a stator core segment and of an electrically insulating member separated from the stator core segment.

FIG. 4 shows a perspective view of an electrically insulating member.

### DETAILED DESCRIPTION

The following detailed description refers to the accompanying drawings that show, by way of illustration, specific details and example embodiments in which the disclosure may be practiced.

The word “exemplary” is used herein to mean “serving as an example, instance, or illustration”. Any example embodiment or design described herein as “exemplary” is not necessarily to be construed as preferred or advantageous over other example embodiments or designs.

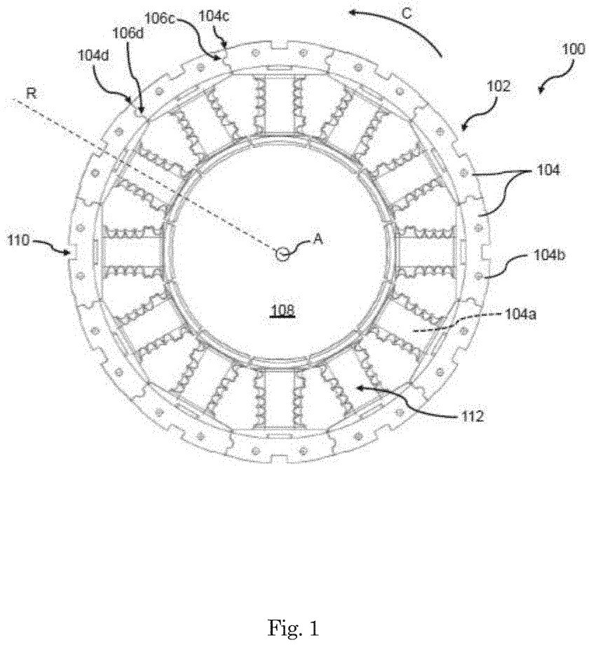

FIG. 1 shows a schematic plan view of an exemplary stator 100 for an electric motor. The stator 100 may include a stator core 102 having a substantially annular shape centered around a central axis A and including a plurality of core segments 104 consecutively arranged in the circumferential direction C of the stator 100. Each core segment 104 includes a coil winding portion 104a around which a respective coil (not shown in the figures) is to be wound. The coil winding portions 104a are configured as elongated members extending in the radial direction R of the stator 100.

As shown in FIG. 1, the core segments 104 may further include a respective core segment flange portion 104b connected to a radially outer end of a respective coil winding portion 104a. The core segment flange portions 104b may serve as means for accurately defining the radially outermost position of the coils. In addition, the core segment flange portions 104b may serve as connecting portions for fixedly connecting two immediately consecutive core segments 104 to each other, e.g., by welding, soldering, or any other suitable fixing means. In the exemplary stator 100 shown in FIG. 1, two immediately consecutive core segments 104 are in mutual physical contact via respective circumferential end surfaces 104c, 104d.

The circumferential end surfaces 104c, 104d may further include form-fit structures 106c, 106d configured to be engaged with complementary form-fit structures of immediately adjacent core segments 104. In the exemplary stator 100 shown in FIG. 1 one of the form-fit structures is configured as a recess 106c, and the respective other one of the form-fit structures is configured as a protrusion 106d complementary to the recess 106c. In this way, the stator 100 may be formed of a plurality of identical core segments 104, since a recess 106c of a core segment 104 can be engaged with a protrusion 106d of an identical immediately adjacent core segment 104.

The exemplary stator 100 shown in FIG. 1 may be fixedly mounted inside of a housing of an electric motor (not shown in the figures) and may be configured to generate a time-varying magnetic field. The electric motor may further include a magnetized rotor rotatably mounted inside of the housing and configured to be rotated by means of a magnetic interaction with the time-varying magnetic field generated by the stator 100. The rotor may be rotatably mounted inside of an inner opening 108 of the stator 100 with a rotational axis thereof parallel to the central axis A of the stator 100.

The electric motor may be mounted in an electric pump configured to convey a liquid such as a service liquid in a vehicle, e.g., lubricating oil or a coolant.

As shown in FIG. 1, at least one of, a plurality of, or even all core segments 104 may be provided with a groove 110 at a radially outer end thereof extending continuously in the axial direction A of the stator 100. The groove 110 may serve as a positioning means for positioning the stator 100 in the interior of a housing of an electric motor.

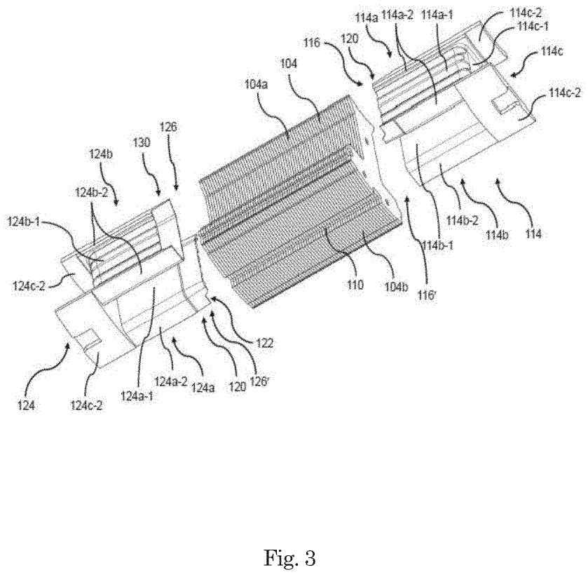

At least one core segment 104, a plurality of core segments 104, or even all core segments 104 may be equipped with an electrically insulating member 112 surrounding a coil winding portion 104a and configured to electrically insulate a core segment 104 from a coil wound around the coil winding portion 104a. In FIG. 1, the coil winding portions 104a of all core segments 104 are equipped with a respective electrically insulating member 112 obscuring the coil winding portions 104a of the core segments 104. Therefore, the line indicating the exemplary coil winding portion 104a is drawn as a dashed line. An exemplary core segment 104 is entirely visible in FIG. 3. The electrically insulating members 112 may be identical. Therefore, reference will be made to only one of the electrically insulating members 112 in the subsequent description.

An electrically insulating member 112 may include: a first insulating member portion 114 including at an end portion 116 thereof a first engagement structure 118 with a wedge-shaped peripheral portion 120 that includes a recess 122 at an end thereof, and a second insulating member portion 124 including at an end portion 126 thereof a second engagement structure 128 including a wedge-shaped peripheral portion 130 and a protrusion 132. The electrically insulating member 112 may include or may be formed of an electrically insulating material having an electrical conductivity of less than 10-8 S/m.

The first engagement structure 118 and the second engagement structure 128 are in mutual engagement or can be brought into mutual engagement. In an engaged state of the first and second engagement structures 118, 128, the wedge-shaped peripheral portions 120, 130 are in mutual physical contact, meaning that they may be positioned in an overlapping relationship. Due to the wedge-shaped configuration, an increase of the thickness of the insulating member 112 in the overlapping region of the first and second engagement structures 118, 128 can be reduced as compared to an insulating member without wedge-shaped peripheral portions. In an example embodiment, the wedge-shaped peripheral portions 120, 130 may be configured with complementary shapes. By means of a configuration of this kind, no increase at all of the thickness of the insulating member 112 in the overlap region may be achieved.

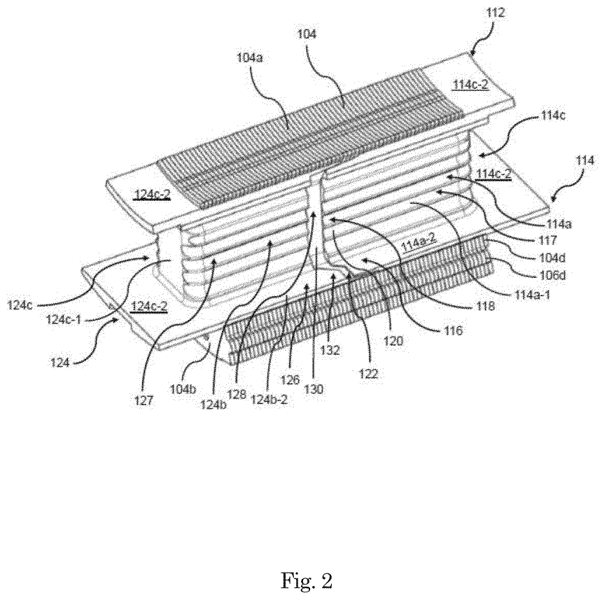

As shown in FIG. 2, in an engaged state of the first and second engagement structures 118, 128, the recess 122 of the first engagement structure 118 is engaged with the protrusion 132 of the second engagement structure 128. In this way, the wedge-shaped peripheral portions 120, 130 can be maintained in a defined positional relationship relative to each other even during the winding of a winding wire around the insulating member 112, i.e., even when exerting forces onto the first and second insulating member portions 114, 124. Consequently, a reliable electrical insulation may be provided by means of a such configured insulating member 112.

As indicated in FIG. 2, in an engaged state, the wedge-shaped peripheral portion 130 of the second engagement structure 128 may be interposed between the coil winding portion 104a of the core segment 104 and the wedge-shaped peripheral portion 120 of the first engagement structure 118. By means of a such configuration, the first and second insulating member portions 114, 124 can be held in a well-defined positional relationship relative to each other, in particular in case the recess 122 and the protrusion 132 are positioned in an edge portion of the first and second insulating member portions 114, 124, respectively. In this case, the protrusion 132 can inhibit a displacement between the first and second engagement structures 118, 128 in case of forces acting on the first engagement structure 118 in a direction towards said edge portion.

As shown in FIGS. 2 to 4, the recess 122 of the first engagement structure 118 may be provided in a corner portion of the wedge-shaped peripheral portion 120 of the first engagement structure 118. This configuration offers the possibility of providing said corner portion and, hence, the recess 122 in a portion of the insulating member 112 that remains visible from the outside even when a coil is wound around the insulating member 112. Consequently, the positional relationship between the first and second engagement structures 118, 128 can be inspected after having wound a coil around the insulating member 112 to check the electrical insulation between the core segment 104 and the coil.

It is conceivable that the first and second insulating member portions 114, 124 are integrally formed and separated from each other only in the region of the first and second engagement structures 118, 128 shown in FIG. 2. A such configured insulating member 112 may be made of an elastically deformable material allowing an elastic deformation of the insulating member 112 for mounting it onto a core segment 104.

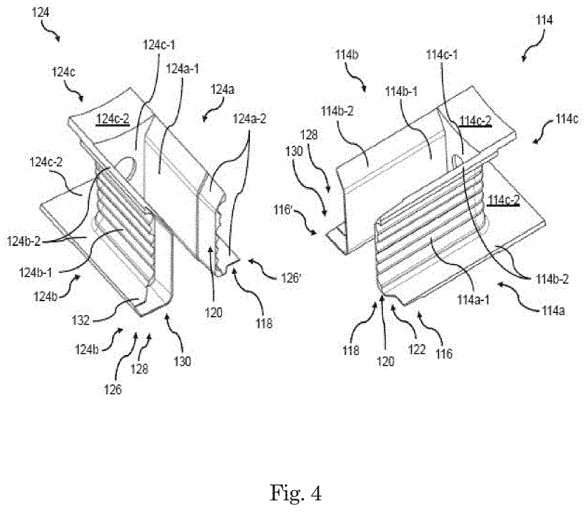

In an alternative example embodiment, the first and second insulating member portions 114, 124 may be formed separately from each other. Such a configuration allows a simple mounting of the insulating member 112 onto a core segment 104 without a substantial elastic deformation of the insulating member 112. A such configured insulating member 112 is shown in FIGS. 3 and 4.

As shown in these figures, the first insulating member portion 114 may have a substantially U-shaped form. The first insulating member portion 114 may include first and second legs 114a, 114b connected to each other at one end by the intermediary of a cross member 114c.

The above-discussed end portion 116 of the first insulating member portion 114 may be provided at an end of the first leg 114a opposite to the end thereof connected to the cross member 114c. This means that the first leg 114a includes at its end opposite to its end connected to the cross member 114c the above-discussed first engagement structure 118.

The second leg 114b may include at an end 116′ thereof opposite to its end connected to the cross member 114c a second engagement structure 128, i.e. a second engagement structure 128 discussed above including a wedge-shaped peripheral portion 130 and a protrusion 132.

As shown in FIGS. 2 to 4, the first leg 114a and/or the second leg 114b and/or the cross member 114c of the first insulating member portion 114 may have a substantially U-shaped cross-sectional form respectively including a central portion 114a-1, 114b-1, and 114c-1 and respective flange portions 114a-2, 114b-2, and 114c-2 at both ends of the respective central portions 114a-1, 114b-1, and 114c-1. In this configuration, a coil may be wound around the central portions 114a-1, 114b-1, and 114c-1 and the flange portions 114a-2, 114b-2, and 114c-2 may serve as positioning means for accurately positioning the coil with respect to the first insulating member portion 114.

The recess 122 of the first engagement structure 118 of the first leg 114a of the first insulating member portion 114 may be formed in a flange portion 114a-2 of the first leg 114a and/or the protrusion 132 of the second engagement structure 128 of the second leg 114b of the first insulating member portion 114 may be formed in a flange portion 114b-2 of the second leg 114b of the first insulating member portion 114. In a such configured first insulating member portion 114, the recess 122 and/or the protrusion 132 may not be obscured by a coil wound around the first insulating member portion 114. Consequently, the position of the recess 122 relative to a protrusion engaged therewith and/or the position of the protrusion 132 relative to a recess engaged therewith is/are visible from the outside so that the relative positions of a recess relative to a corresponding protrusion can be inspected even after a coil has been wound around the insulating member 112. Consequently, it is possible to check whether a coil is reliably electrically insulated from a core segment 104 or not.

The respective central portions 114a-1, 114b-1, and 114c-1 of the first leg 114a, the second leg 114b, and the cross member 114c of the first insulating member portion 114 may include a plurality of longitudinal grooves 117 on a surface thereof opposite to the coil winding portion 104a of the core segment 104. The longitudinal grooves 117 may serve as guiding means for winding wires of a coil to be wound around the insulating member 112. In the example embodiment shown in the figures, the cross member 114c of the first insulating member portion 114 does not have longitudinal grooves. However, it is self-evident that the cross member 114c may also be provided with longitudinal grooves.

As shown in FIGS. 2 to 4, the second insulating member portion 124 may also have a substantially U-shaped form including first and second legs 124a, 124b connected to each other at one end by the intermediary of a cross member 124c.

The above-discussed end portion 126 of the second insulating member portion 124 may be provided at an end of the second leg 124b of the second insulating member portion 124 opposite to the end thereof connected to the cross member 124c. This means that the second leg 124b of the second insulating member portion 124 may include at its end opposite to its end connected to the cross member 124c the above-discussed second engagement structure 128.

The first leg 124a of the second insulating member portion 124 may include at an end 126′ thereof opposite to its end connected to the cross member 124c a first engagement structure 118, i.e. an engagement structure including a wedge-shaped peripheral portion 120 and a recess 122.

As shown in FIGS. 2 to 4, the first leg 124a and/or the second leg 124b and/or the cross member 124c of the second insulating member portion 124 may have a substantially U-shaped cross-sectional form respectively including a central portion 124a-1, 124b-1, and 124c-1 and respective flange portions 124a-2, 124b-2, and 124c-2 at both ends of the respective central portion 124a-1, 124b-1, and 124c-1. In this configuration, a coil may be wound around the respective central portions 124a-1, 124b-1, and 124c-1 and the flange portions 124a-2, 124b-2, and 124c-2 may serve as positioning means for accurately positioning the coil with respect to the second insulating member portion 124.

The recess 122 of the first engagement structure 118 of the first leg 124a of the second insulating member portion 124 may be formed in a flange portion 124a-2 of the first leg 124a and/or the protrusion 132 of the second engagement structure 128 of the second leg 124b of the second insulating member portion 124 may be formed in a flange portion 124b-2 of the second leg 124b of the second insulating member portion 124. In a such configured second insulating member portion 124, the recess 122 and/or the protrusion 132 are not obscured by a coil wound around the second insulating member portion 124. Consequently, the position of the recess 122 relative to a protrusion engaged therewith and/or the position of the protrusion 132 relative to a recess engaged therewith is/are visible from the outside so that the relative positions of a recess relative to a corresponding protrusion can be inspected even after a coil has been wound around the insulating member 112. Consequently, it is possible to check whether a coil is reliably electrically insulated from a core segment 104 or not.

The central portions 124a-1, 124b-1, 124c-1 of the first leg 124a, the second leg 124b, and the cross member 124c, respectively, may include a plurality of longitudinal grooves 127 on a surface thereof opposite to the coil winding portion 104a of the core segment 104. As mentioned previously with respect to the first insulating member portion 114, the longitudinal grooves 127 may serve as guiding means for the winding wires of a coil to be wound around the insulating member 112. In the example embodiment shown in the figures, the cross member 124c of the second insulating member portion 124 does not have longitudinal grooves. It is, however, self-evident that the cross member 124c may also be provided with longitudinal grooves.

The first and second insulating member portions 114, 124 of the example embodiment described with reference to FIGS. 2 to 4 may be identical. In a mounted state, the first engagement structure 118 of the first leg 114a of the first insulating member portion 114 may be engaged with the second engagement structure 128 of the second leg 124b of the second insulating member portion 124, and the second engagement structure 128 of the second leg 114b of the first insulating member portion 114 may be engaged with the first engagement structure 118 of the first leg 124a of the second insulating member portion 124. By the provision of identical first and second insulating member portions 114 and 124, the insulating member 112 may be manufactured in a simple way.

The present disclosure is, however, not limited to identically formed first and second insulating member portions.

In an alternative example embodiment not shown in the figures, the insulating member may also include two insulating member portions formed separately from each other. Similar to the above-described example embodiment, each of the first and second insulating member portions may have a substantially U-shaped form respectively including first and second legs connected at respective ends to a cross member. Different from the above described example embodiment, however, the first and second legs of the first insulating member portion may be identical, and the first and second legs of the second insulating member portion may be identical.

Each of the first and second legs of the first insulating member portion may have first engagement structures at respective ends opposite to their respective ends connected to the cross member of the first insulating member portion.

Each of the first and second legs of the second insulating member portion may have second engagement structures at respective ends opposite to their respective ends connected to the cross member of the second insulating member portion.

In a mounted state, the first engagement structures provided at the ends of the first and second legs of the first insulating member portion may be respectively engaged with the second engagement structures provided at the ends of the first and second legs of the second insulating member portion.

The first and second insulating member portions may have all the other or equivalent features described above with reference to the figures. Some of these features will be briefly summarized in the following.

Some or each of the legs and the cross members of the first and second insulating member portions may have substantially U-shaped cross-sectional forms including a central portion and respective flange portions at both ends of the central portion.

The recess of the first engagement structure of the first leg of the first insulating member portion may be formed in a flange portion of the first leg and/or the recess of the first engagement structure of the second leg of the first insulating member portion may be formed in a flange portion of the second leg.

The protrusion of the second engagement structure of the first leg of the second insulating member portion may be formed in a flange portion of the first leg and/or the protrusion of the second engagement structure of the second leg of the second insulating member portion may be formed in a flange portion of the second leg.

The central portion of the first leg and/or the second leg and/or the cross member of the first and/or second insulating member portion may include a plurality of longitudinal grooves on a surface opposite to the coil winding portion of the corresponding core segment.

In the following, various examples of the present disclosure will be described.

Example 1 is a stator for an electric motor including a stator core having a substantially annular shape centered around a central axis and including a plurality of core segments consecutively arranged in the circumferential direction of the stator. Each core segment may include a coil winding portion around which respective coils are to be wound. At least one core segment may be equipped with an electrically insulating member surrounding the coil winding portion thereof and configured to electrically insulate the at least one core segment from a coil wound around the at least one core segment. The electrically insulating member may include: a first insulating member portion including at an end portion thereof a first engagement structure with a wedge-shaped peripheral portion that includes a recess at an end thereof, and a second insulating member portion including at an end portion thereof a second engagement structure including a wedge-shaped peripheral portion and a protrusion. The first and second engagement structures may be in mutual engagement or can be brought into mutual engagement. In an engaged state of the first and second engagement structures, the wedge-shaped peripheral portions may be in mutual physical contact, and the recess of the first engagement structure may be engaged with the protrusion of the second engagement structure.

In Example 2, the subject matter of Example 1 can optionally further include that in an engaged state, the wedge-shaped peripheral portion of the second engagement structure is interposed between the coil winding portion of the at least one core segment and the wedge-shaped peripheral portion of the first engagement structure.

In Example 3, the subject matter of any one of Examples 1 or 2 can optionally further include that the recess of the first engagement structure is provided in a corner portion of the wedge-shaped peripheral portion of the first engagement structure.

In Example 4, the subject matter of any one of Examples 1 to 3 can optionally further include that the first and second insulating member portions are separately formed from each other.

In Example 5, the subject matter of Example 4 can optionally further include that the first insulating member portion includes at another end portion thereof an additional first engagement structure, and the second insulating member portion includes at another end portion thereof an additional second engagement structure. The additional first engagement structure of the first insulating member portion may be engaged or can be brought into engagement with the additional second engagement structure of the second insulating member portion.

In Example 6, the subject matter of Example 4 can optionally further include that the first insulating member portion includes at another end portion thereof a second engagement structure, and the second insulating member portion includes at another end portion thereof a first engagement structure. The first engagement structure of the second insulating member portion may be engaged or can be brought into engagement with the second engagement structure of the first insulating member portion.

In Example 7, the subject matter of any one of Examples 1 to 6 can optionally further include that the first insulating member portion has a substantially U-shaped form including first and second legs connected to each other at one end by a cross member.

In Example 8, the subject matter of Examples 5 and 7 can optionally further include that each of the first and second legs of the first insulating member portion includes at respective ends opposite to the ends connected to the cross member a first engagement structure.

In Example 9, the subject matter of Examples 6 and 7 can optionally further include that the first leg of the first insulating member portion includes at an end opposite to the end connected to the cross member a first engagement structure, and the second leg of the first insulating member portion includes at an end opposite to the end connected to the cross member a second engagement structure.

In Example 10, the subject matter of any one of Examples 7 to 9 can optionally further include that the first leg and/or the second leg and/or the cross member of the first insulating member portion has/have a substantially U-shaped cross-sectional form including a central portion and respective flange portions at both ends of the central portion.

In Example 11, the subject matter of Examples 8 and 10 can optionally further include that the recess of the first engagement structure of the first leg of the first insulating member portion is formed in a flange portion of the first leg and/or the recess of the first engagement structure of the second leg of the first insulating member portion is formed in a flange portion of the second leg.

In Example 12, the subject matter of Examples 9 and 10 can optionally further include that the recess of the first engagement structure of the first leg of the first insulating member portion is formed in a flange portion of the first leg and/or the protrusion of the second engagement structure of the second leg of the first insulating member portion is formed in a flange portion of the second leg.

In Example 13, the subject matter of any one of Examples 10 to 12 can optionally further include that the central portion/portions of the first leg and/or the second leg and/or the cross member of the first insulating member portion includes/include a plurality of longitudinal grooves on a surface thereof opposite to the coil winding portion of the at least one core segment.

In Example 14, the subject matter of any one of Examples 1 to 13 can optionally further include that the second insulating member portion has a substantially U-shaped form including first and second legs connected to each other at one end by a cross member.

In Example 15, the subject matter of Examples 5 and 14 can optionally further include that each of the first and second legs of the second insulating member portion includes at respective ends opposite to the ends connected to the cross member a second engagement structure.

In Example 16, the subject matter of Examples 6 and 14 can optionally further include that the first leg of the second insulating member portion includes at an end opposite to the end connected to the cross member a first engagement structure, and the second leg of the second insulating member portion includes at an end opposite to the end connected to the cross member a second engagement structure.

In Example 17, the subject matter of any one of Examples 14 to 16 can optionally further include that the first leg and/or the second leg and/or the cross member of the second insulating member portion has/have a substantially U-shaped cross-sectional form including a central portion and respective flange portions at both ends of the central portion.

In Example 18, the subject matter of Examples 15 and 17 can optionally further include that the protrusion of the second engagement structure of the first leg of the second insulating member portion is formed in a flange portion of the first leg and/or the protrusion of the second engagement structure of the second leg of the second insulating member portion is formed in a flange portion of the second leg.

In Example 19, the subject matter of Examples 16 and 17 can optionally further include that the recess of the first engagement structure of the first leg of the second insulating member portion is formed in a flange portion of the first leg and/or the protrusion of the second engagement structure of the second leg of the second insulating member portion is formed on a flange portion of the second leg.

In Example 20, the subject matter of any one of Examples 17 to 19 can optionally further include that the central portion/portions of the first leg and/or the second leg and/or the cross member of the second insulating member portion includes/include a plurality of longitudinal grooves on a surface opposite to the coil winding portion of the at least core segment.

In Example 21, the subject matter of any one of Examples 1 to 20 can optionally further include that at least one core segment includes a core segment flange portion connected to the coil winding portion of the at least one core segment at a radially outer end of the coil winding portion of the at least one core segment.

In Example 22, the subject matter of Example 21 can optionally further include that two immediately consecutive core segments respectively include a core segment flange portion, wherein the core segment flange portions of the two immediately consecutive core segments are fixedly connected to each other.

Example 23 is an electric motor including: a housing, a stator of any one of Examples 1 to 22 fixedly mounted inside of the housing and configured to generate a time-varying magnetic field, and a rotor rotatably mounted inside of the housing and configured to be rotated by means of a magnetic interaction with the time-varying magnetic field generated by the stator.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-23. (canceled)

24. A stator for an electric motor, the stator comprising:
a stator core having a substantially annular shape centered around a central axis and including a plurality of core segments consecutively arranged in a circumferential direction of the stator; wherein
each of the plurality of core segments includes a coil winding portion around which respective coils are to be wound;
at least one core segment includes an electrical insulator surrounding the coil winding portion thereof to electrically insulate the at least one core segment from a coil wound around the at least one core segment;
the electrical insulator includes:
a first insulator portion including at an end portion thereof a first engagement structure with a wedge-shaped peripheral portion that includes a recess at an end thereof; and
a second insulator portion including at an end portion thereof a second engagement structure including a wedge-shaped peripheral portion and a protrusion;
the first and second engagement structures are in mutual engagement or are able to be brought into mutual engagement;
in an engaged state of the first and second engagement structures, the wedge-shaped peripheral portions are in mutual physical contact; and
the recess of the first engagement structure is engaged with the protrusion of the second engagement structure.

25. The stator of claim 24, wherein in the engaged state, the wedge-shaped peripheral portion of the second engagement structure is interposed between the coil winding portion of the at least one core segment and the wedge-shaped peripheral portion of the first engagement structure.

26. The stator of claim 24, wherein the recess of the first engagement structure is located in a corner portion of the wedge-shaped peripheral portion of the first engagement structure.

27. The stator of claim 24, wherein the first and second insulator portions are separate structures from each other.

28. The stator of claim 27, wherein the first insulator portion includes at another end portion thereof an additional first engagement structure, and the second insulator portion includes at another end portion thereof an additional second engagement structure, and the additional first engagement structure of the first insulator portion is engaged or able to be brought into engagement with the additional second engagement structure of the second insulator portion.

29. The stator of claim 27, wherein
the first insulator portion includes at another end portion thereof a second engagement structure;
the second insulator portion includes at another end portion thereof a first engagement structure; and
the first engagement structure of the second insulator portion is engaged or able to be brought into engagement with the second engagement structure of the first insulator portion.

30. The stator of claim 24, wherein the first insulator portion has a substantially U-shaped structure including first and second legs connected to each other at one end by a cross-connector.

31. The stator of claim 30, wherein each of the first and second legs of the first insulator portion includes at respective ends opposite to the ends connected to the cross-connector a first engagement structure.

32. The stator of claim 30, wherein the first leg of the first insulator portion includes at an end opposite to the end connected to the cross-connector a first engagement structure, and the second leg of the first insulator portion includes at an end opposite to the end connected to the cross-connector a second engagement structure.

33. The stator of claim 30, wherein at least one of the first leg and the second leg, and the cross-connector of the first insulator portion has a substantially U-shaped cross-sectional structure including a central portion and respective flange portions at both ends of the central portion.

34. The stator of claim 33, wherein the recess of the first engagement structure of the first leg of the first insulator portion is provided in a flange portion of the first leg and/or the recess of the first engagement structure of the second leg of the first insulator portion is provided in a flange portion of the second leg.

35. The stator of claim 33, wherein the recess of the first engagement structure of the first leg of the first insulator portion is provided in a flange portion of the first leg and/or the protrusion of the second engagement structure of the second leg of the first insulator portion is provided in a flange portion of the second leg.

36. The stator of claim 33, wherein at least the central portion of the first leg and the central portion of the second leg and the cross-connector of the first insulator portion includes a plurality of longitudinal grooves on a surface thereof opposite to the coil winding portion of the at least one core segment.

37. The stator of claim 24, wherein the second insulator portion has a substantially U-shaped structure including first and second legs connected to each other at one end by a cross-connector.

38. The stator of claim 37, wherein each of the first and second legs of the second insulator portion includes at respective ends opposite to the ends connected to the cross-connector a second engagement structure.

39. The stator of claim 37, wherein the first leg of the second insulator portion includes at an end opposite to the end connected to the cross-connector a first engagement structure, and the second leg of the second insulator portion includes at an end opposite to the end connected to the cross-connector a second engagement structure.

40. The stator of claim 37, wherein at least one of the first leg and the second leg and the cross-connector of the second insulator portion has a substantially U-shaped cross-sectional structure including a central portion and respective flange portions at both ends of the central portion.

41. The stator of claim 40, wherein the protrusion of the second engagement structure of the first leg of the second insulator portion is provided in a flange portion of the first leg and/or the protrusion of the second engagement structure of the second leg of the second insulator portion is provided in a flange portion of the second leg.

42. The stator of claim 40, wherein the recess of the first engagement structure of the first leg of the second insulator portion is provided in a flange portion of the first leg and/or the protrusion of the second engagement structure of the second leg of the second insulator portion is provided in a flange portion of the second leg.

43. The stator of claim 40, wherein at least one of the central portion of the first leg and the central portion of the second leg and the cross-connector of the second insulator portion includes a plurality of longitudinal grooves on a surface opposite to the coil winding portion of the at least core segment.

44. An electric motor, comprising:
a housing;
the stator of claim 24 fixedly mounted inside of the housing to generate a time-varying magnetic field; and
a rotor rotatably mounted inside of the housing to be rotated by a magnetic interaction with the time-varying magnetic field generated by the stator.
